(19) United States
(12) Patent Application Publication
(10) Pub. No.: US 2021/0033191 A1
(43) Pub. Date: Feb. 4, 2021

(54) PARKING LOCK FOR A MOTOR VEHICLE, IN PARTICULAR FOR AN AUTOMOBILE, METHOD FOR OPERATING SUCH A PARKING LOCK, TRANSMISSION AND MOTOR VEHICLE

(71) Applicant: AUDI AG, Ingolstadt (DE)

(72) Inventor: Rupert WAGNER, Kühbach (DE)

(73) Assignee: AUDI AG, Ingolstadt (DE)

(21) Appl. No.: 16/965,105

(22) PCT Filed: Feb. 14, 2019
(86) PCT No.: PCT/EP2019/053644

§ 371 Date: Jul. 27, 2020

(30) Foreign Application Priority Data
Mar. 23, 2018 (DE) 10 2018 204 507.0

(51) Int. Cl. F16H 63/34; B60T 1/00

(52) U.S. Cl. CPC F16H 63/3433; F16H 63/3466; B60T 1/005

(57) ABSTRACT

A parking lock for motor vehicle, including a parking lock wheel that can be connected to a shaft of the motor vehicle in a rotationally fixed manner, at least one blocking element, and an actuator, by which the blocking element is movable between at least one blocking position securing the parking lock wheel against rotation, and at least one release position releasing the parking lock wheel for a rotation, comprising at least one spring element, which by the actuator is to be tensioned during the moving of the blocking element into the blocking position, thus providing a spring force in the blocking position of the blocking element, by which the actuator is to be supported during the movement of the blocking element into the release position.

The invention relates to a parking lock for a motor vehicle according to the preamble of claim 1. Furthermore, the invention relates to a method for operating such a parking lock according to the preamble of claim 11. In addition, the invention relates to a transmission and a motor vehicle.

Such a parking lock for a motor vehicle, in particular for an automobile, as well as such a method for operating such a parking lock are already known, for example, from DE 10 2010 038 513 A1. The parking lock has a parking lock wheel that can be connected to a shaft of the motor vehicle, in particular of a transmission of the motor vehicle, in a rotationally fixed manner and at least one blocking element which is formed, for example, as a locking pawl. Furthermore, the parking lock comprises an actuator, by means of which the blocking element is movable between at least one blocking position securing the parking lock wheel against rotation and at least one release position releasing the parking lock wheel for a rotation. This means that the blocking element secures the parking lock wheel against a rotation in the blocking position in that, for example, the blocking element interacts with the parking lock wheel. In the release position, an interaction between the blocking element and the parking lock wheel securing the parking lock wheel against a rotation, for example, is suppressed to the extent that the blocking element releases the parking lock wheel in the release position. As a result, the parking lock wheel and thus the shaft can rotate.

The object of the present invention is to further develop a parking lock, a method, a transmission, and a motor vehicle of the aforementioned type to the extent that the weight and the installation space required for the parking lock can be kept to an especially small scope.

Said object is achieved by means of a parking lock with the features of claim 1, by means of a method with the features of claim 11, by means of a transmission with the features of claim 12, as well as by means of a motor vehicle with the features of claim 13. Advantageous embodiments with suitable further embodiments of the invention are indicated in the remaining claims.

A first aspect of the invention relates to a parking lock for a motor vehicle, particularly for an automobile such as, for example, a passenger car. The parking lock has at least one parking lock wheel that can be connected to a shaft of the motor vehicle, in particular to a shaft of a transmission of the motor vehicle, in a rotationally fixed manner, said parking lock wheel being connected, in a rotationally fixed manner, to the shaft, which is formed as a transmission shaft for example, in the completely manufactured state of the motor vehicle. Thus, in its completely manufactured state for example, the transmission has the shaft and the parking lock wheel connected thereto in a rotationally fixed manner, wherein the shaft and the parking lock wheel are essentially rotatable about an axis of rotation of the shaft relative to a housing of the transmission. In this case, the shaft and the parking lock wheel, for example, are arranged in the housing. Moreover, the parking lock comprises at least one blocking element and a particularly electrically drivable actuator, by means of which the blocking element is movable between at least one blocking position securing the parking lock wheel against a rotation and at least one release position releasing the parking lock wheel for a rotation. This means that the blocking element secures the parking lock wheel in the blocking position against a rotation, particularly a rotation about the axis of rotation of the shaft relative to the housing, to the extent that the parking lock wheel and the shaft, for example, cannot rotate about the axis of rotation of the shaft relative to the housing. To this end, the blocking element, for example, is at least indirectly coupled to the housing, particularly such that the parking lock wheel and thus the shaft are secured, via the blocking element, against a rotation about the axis of rotation of the shaft relative to the housing, in the blocking position of the blocking element.

However, the blocking element, for example, is movable relative to the housing between the release position and the blocking position by means of the actuator. This means particularly that the actuator can move the blocking element, particularly electrically, from the blocking position into the release position as well as from the release position into the blocking position, particularly relative to the housing. In the blocking position, the blocking element interacts with the parking lock wheel in a positive-locking manner, whereby the parking lock wheel is secured against a rotation, particularly relative to the housing. Because the parking lock wheel is connected to the shaft in a rotationally fixed manner in the completely manufactured state of the motor vehicle and/or of the transmission, the shaft is also secured, by means of the blocking element, against a rotation relative to the housing. In the blocking position, the blocking element thereby interacts with the parking lock wheel in a positive-locking manner such that the blocking element in the blocking position engages a corresponding recess of the parking lock wheel, said recess particularly being on the outer periphery.

In the release position however, the blocking element releases the parking lock wheel and thus the shaft for a rotation to the extent that the parking lock wheel and thus the shaft can rotate, particularly about the axis of rotation of the shaft relative to the housing. To this end, it is provided, for example, that an interaction between the blocking element and the parking lock wheel securing the parking lock wheel against a rotation is suppressed, in the release position. In other words, in the release position, the blocking element does not interact with the parking lock wheel to the extent that the parking lock wheel and thus the shaft can rotate about the axis of rotation of the shaft, particularly relative to the housing.

In the completely manufactured state of the motor vehicle, the shaft, for example, is coupled to at least one or more wheels of the motor vehicle in a torque-transferring manner to the extent that torques can be transferred between the respective wheel and the shaft and/or to the extent that a torque and/or force path is closed between the shaft and the respective wheel, wherein torques and/or forces can be transferred via the torque and/or force path. In the blocking position, because the shaft, via the parking lock wheel, and the blocking element are secured against a rotation relative to the housing, the respective wheel is also secured against a rotation, particularly a rotation relative to a structure of the motor vehicle formed, for example, as a self-supporting body, to the extent that the respective wheel cannot rotate relative to the structure. By means of the parking lock, particularly by means of the blocking element in the blocking position, the motor vehicle can be prevented from rolling away unintentionally which is particularly advantageous when the motor vehicle is stopped or parked, for example, on an incline or on a slope. In order to again move or drive the motor vehicle intentionally, the blocking element is moved from the blocking position into the release position by means of the actuator.

In order to then keep the installation space required and the weight of the parking lock especially low, it is provided according to the invention that the parking lock has at least one spring element, which, by means of the actuator, is to be tensioned during the moving of the blocking element into the blocking position, which can be effected by means of the actuator, thus providing a spring force in the blocking position of the blocking element, by means of which the actuator is to be supported during the movement of the blocking element into the release position. In other words, if the blocking element is moved from the release position into the blocking position by means of the actuator, the spring element is tensioned by means of the actuator during said movement. As a result, the spring element is tensioned more strongly in the blocking position of the blocking element than it is in the release position. In doing so, it may be provided that the spring element is tensioned in the release position but not as strongly as in the blocking position. Due to the fact that the spring element is tensioned in the blocking position, the spring element provides the aforementioned spring force. Preferably, the spring force is minimal such that a moving of the blocking element, which is effected or can be effected by means of the spring force, from the blocking position into the release position is suppressed. In other words, the spring force is minimal enough, for example, such that the spring force cannot move the blocking element from the blocking position into the release position. However, the spring force, for example, acts in a direction such that or the spring force effects such an actuation torque or such an actuation force which acts in a direction such that the actuator is supported by means of the spring force provided by the spring element when the actuator moves the blocking element, particularly in a targeted or active manner, from the blocking position into the release position.

In order to move the blocking element from the blocking position into the release position, at least one moving force and/or one moving torque is required, for example, which is to be exerted, for example, at least indirectly onto the blocking element. Because the actuator is then supported, by the spring force provided by the spring element, during moving of the blocking element from the blocking position into the release position, the actuator does not have to provide or apply the moving force and/or the moving torque alone; instead, a first part of the moving force and/or of the moving torque is effected by means of the actuator or provided by the actuator, and a second part of the moving force and/or of the moving torque is effected and/or provided by the spring force provided by the spring element, wherein, for example, the parts as a whole provide at least the moving force and/or the moving torque. The weight, the installation space requirement, and the costs of the actuator can hereby be kept especially low to the extent that a structure of the actuator and thus of the parking lock can be represented as a whole which is beneficial to weight, cost, and installation space.

The respective part per se or considered in isolation, for example, is less than the moving force and/or the moving torque to the extent that the respective part alone, for example, is not sufficient for moving the blocking element from the blocking position into the release position. The parts as a whole, however, correspond at least to the moving force and/or the moving torque or is greater than the moving force and/or the moving torque to the extent that the blocking element can be moved or is moved from the blocking position into the release position partially by means of the spring force and partially by means of the actuator. In other words, an actuator force provided by the actuator and the spring force, for example, are added together to the extent that the spring element can be moved from the blocking position into the release position.

In this case, the invention is particularly based on the following knowledge: The actuation of conventional parking locks is normally carried out by an electric actuator, the size of which is based on the maximum occurring forces. With a parking lock, the releasing of the tensioned blocking element is the case with the maximum force requirement when the blocking element, which is formed, for example, as a pawl or a locking pawl, is thereby tensioned to the extent that the motor vehicle is parked on a slope or an incline and is secured against rolling away, for example, only by means of the parking lock. The blocking element and/or the downhill force resulting from the weight force of the motor vehicle is then tensioned with the parking lock wheel. The maximum force requirement in this case is so high that it leads to an actuator which requires much installation space, weight, and cost.

The aforementioned disadvantages can be prevented, however, by means of the parking lock according to the invention. With the parking lock according to the invention, the spring element functions as an additional pre-loaded spring, which is integrated into the parking lock. The pre-loaded spring is tensioned or pre-loaded in the blocking position of the blocking element and provides the previously described spring force, by means of which the actuator is supported during moving of the blocking element from the blocking position into the release position. Due to the fact that the spring element is tensioned by means of the actuator when the blocking element is moved from the release position into the blocking position by means of the actuator, the blocking element can be moved, for example, from the release position into the park position at least almost exactly as quickly as with conventional parking locks. Due to the tensioning of the spring element, a force and/or an energy is stored in the spring element, which is provided by the actuator. This force and/or energy stored in the spring element in the blocking position is used to support the actuator during the moving of the blocking element from the blocking position into the release position.

The moving of the blocking element from the blocking position into the release position is also characterized as releasing the blocking element and/or the parking lock. During releasing of the parking lock, the pre-loaded spring element and/or the spring force of the parking lock acts in a direction, particularly in a direction of rotation, such that the actuator is supported during moving of the blocking element from the blocking position into the release position.

The previously described total of the parts in this case is large enough such that the blocking elements can be moved, even in the previously described case with the maximum force requirement, from the blocking position into the release position to the extent that a releasing of the parking lock can be ensured.

In an advantageous embodiment of the invention, the actuator has a self-locking function, by means of which the blocking element is to be retained or is retained against the spring force provided by the spring element in the blocking position. Additional securing and/or retaining or braking elements, which are high in installation space, weight, and cost, can be avoided to the extent that the number of parts, the costs, the installation space requirement, and the weight of the parking lock can be kept within an especially low scope. In order to implement the self-locking function, the actuator has worm gearing, for example, by means of the self-locking of which the blocking element can be retained against the spring force provided by the spring element, in the blocking position. Due to the fact that the actuator has the self-locking function, the actuator is also characterized as a self-locking actuator.

In a further embodiment of the invention, the spring element is formed as a rotary spring, the spring force of which effects a torque, at least in the blocking position, by means of said torque the actuator is to be supported or is supported during the movement of the blocking element from the blocking position into the release position. The installation space requirement can hereby be kept to an especially low scope.

A further embodiment has at least one coupling element, by means of which the blocking element can be moved by the actuator or by means of the actuator. The spring force in this case, at least in the blocking position, acts on the coupling element at least indirectly, particularly directly, whereby the actuator is to be supported or is supported, via the coupling element, during the movement of the blocking element from the blocking position into the release position by means of the spring force. In other words, it is provided with this embodiment that the spring force acts on the actuator and/or supports the actuator during movement of the blocking element into the release position, with assistance of the coupling element. An especially compact and economical construction can thereby be ensured.

In order to keep the installation space requirement especially low in this case, it is provided in a further embodiment of the invention that the coupling element is a coupling shaft rotatable about an axis of rotation, particularly relative to the aforementioned housing of the transmission. The coupling shaft is a shaft which is designated as a coupling shaft in order to clearly differentiate conceptually the coupling shaft from the shaft of the transmission, because the shaft and the coupling shaft are preferably two individual components produced separately from one another.

In this case, it has been shown to be especially advantageous when the torque is effected around the axis of rotation of the coupling shaft, at least in the blocking position, whereby the installation space requirement can be kept especially low.

In an especially advantageous embodiment of the invention, the actuator is formed as an electric motor and as a rotating motor in this case, which has a stator and a rotor. The rotor can be driven by the stator and can thereby be rotated about an axis of rotation of the motor relative to the stator. In this case, the coupling shaft can be driven by the rotor. Preferably, the coupling shaft is connected to the rotor in a rotationally fixed manner The installation space requirement can hereby be kept to an especially low scope by means of this embodiment of the actuator.

In a further embodiment of the invention, it is provided that the rotor is arranged coaxially to the coupling shaft to the extent that the axis of the motor coincides with the axis of rotation of the coupling shaft. A structure of the parking lock which is especially compact and thus beneficial regarding the installation space can thereby be implemented.

A further embodiment is characterized in that the blocking element, which is formed, for example, as a pawl or as a locking pawl, can be moved or displaced translationally, particularly relative to the housing, along a direction of movement or along an axis of movement, between the release position and the blocking position. An especially small installation space can thereby be ensured.

In order to obtain a construction especially beneficial to the installation space in this case, it is provided in a further embodiment of the invention that the direction of movement and/or the axis of movement extends diagonally or skewed as relates to the axis of rotation.

A second aspect of the invention relates to a method for operating a parking lock, particularly a parking lock according to the invention, for a motor vehicle. The parking lock has a parking lock wheel which can be connected to a shaft of the motor vehicle in a rotationally fixed manner, at least one blocking element, and an actuator, by means of which the blocking element is moved between at least one blocking position securing the parking lock wheel against a rotation and at least one release position releasing the parking lock wheel for a rotation.

In order to then keep the installation space requirement for the parking lock low, at least one spring element is provided according to the invention, which is tensioned by means of the actuator, while the blocking element is moved from the release position into the blocking position by means of the actuator. The spring element hereby provides, at least in the blocking position, a spring force, by means of which the actuator is supported during the movement of the blocking element from the blocking position into the release position. Advantages and advantageous embodiments of the first aspect of the invention should be considered advantages and advantageous embodiments of the second aspect of the invention and vice versa.

A third aspect of the invention relates to a transmission for a motor vehicle, wherein the transmission has at least one parking lock according to the invention in accordance with the first aspect of the invention. Advantages and advantageous embodiments of the first aspect and of the second aspect of the invention should be considered advantages and advantageous embodiments of the third aspect of the invention and vice versa.

A fourth aspect of the invention relates to a motor vehicle, particularly to an automobile, wherein the motor vehicle has at least one parking lock according to the invention in accordance with the first aspect of the invention and/or at least one transmission according to the third aspect of the invention. Advantages and advantageous embodiments of the first aspect, of the second aspect, and of the third aspect of the invention in this case should be considered advantages and advantageous embodiments of the fourth aspect of the invention and vice versa.

An exemplary embodiment of the invention is described in the following. The following is shown:

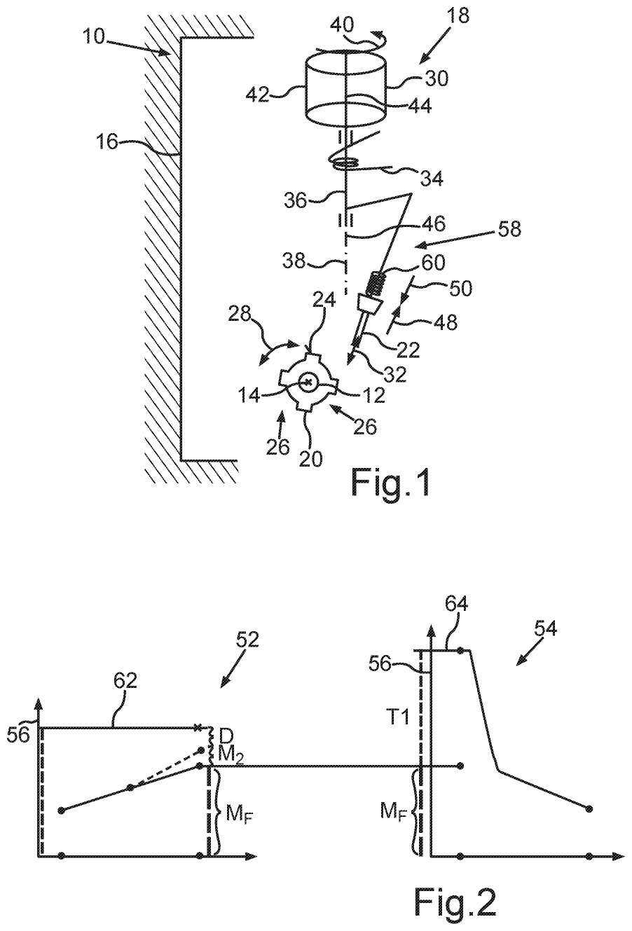

FIG. 1 a schematic representation of a transmission according to the invention with a parking lock according to the invention; and

FIG. 2 diagrams to illustrate the parking lock.

The exemplary embodiment explained in the following refers to a preferred embodiment of the invention. With the exemplary embodiment, the described components of the embodiments represent individual features of the invention that are to be considered independently of one another, each of which also further develop the invention independently of one another and thus also are to be considered individually or in a combination that is different than the one shown as a component of the invention. Furthermore, the described embodiment can also be supplemented through further described features of the invention.

In the figures, elements which are functionally equivalent are each given the same reference numerals.

FIG. 1 shows a schematic, sectional view of a transmission 10 for a motor vehicle formed, for example, as an automobile, particularly as a passenger car. In its completely manufactured state, the motor vehicle has at least one drive motor, the transmission 10, and at least one or more wheels, which can be driven by the drive motor via the transmission 10. Furthermore, in its completely manufactured state, the motor vehicle has a structure formed, for example, as a self-supporting body, wherein the respective wheel can rotate relative to the structure via a respective axis of rotation of the wheel. In other words, if the respective wheel is driven by the drive motor via the transmission 10, the respective wheel thus rotates about its axis of rotation of the wheel relative to the structure. To this end, the respective wheel is coupled to a shaft 12 of the transmission 10 in a torque-transferring manner via an axle drive. The shaft 12 in this case can be driven by the drive motor to the extent that the respective wheel can be driven by the drive motor via the shaft 12. Furthermore, the respective wheel, for example, can rotate about its respective axis of rotation of the wheel relative to the structure and relative to a housing 16 of the transmission 10, which is also characterized as the transmission housing. Essentially, the shaft 12 is rotatable about the axis of rotation of the shaft 14 relative to the housing 16 and relative to the structure.

Furthermore, the transmission 10 has a parking lock 18, which is arranged, for example, at least partially, particularly at least predominantly or completely, in the housing 16. The parking lock 18 comprises a parking lock wheel 20, which is rotatably connected to the shaft 12 and thus is rotatable, with the shaft 12, about the axis of rotation of the shaft 14 relative to the housing 16.

Moreover, the parking lock 18 comprises at least or precisely one locking element 22, which is also characterized, for example, as a locking pawl or parking lock pawl. The blocking element 22 is movable between at least one blocking position securing the parking lock wheel 20 and thus the shaft 12 against a rotation about the axis of rotation of the shaft 14 relative to the housing 16 and at least one release position, shown in FIG. 1, releasing the parking lock wheel 20 as well as the shaft 12 for a rotation about the axis of rotation of the shaft 14 relative to the housing 16. The parking lock wheel 20 has, for example on its shell surface 24 on the outer periphery, several recesses 26, which are spaced apart from one another and sequential in the circumferential direction of the parking lock wheel 20 extending about the axis of rotation of the shaft 14. The circumferential direction of the parking lock wheel 20 is indicated by a double arrow 28 in FIG. 1. In the blocking position, the blocking element 22, for example, engages one of the recesses 26, whereby the blocking element 22 interacts with the parking lock wheel 20 in a positive-locking manner The blocking element 22 is movable between the release position and the blocking position relative to the housing 16 and, in doing so however, is retained, at least indirectly, on the housing 16 to the extent that the parking lock wheel 20, in the blocking position, is secured against a rotation about the axis of rotation of the shaft 14 relative to the housing 16 via the blocking element 22. Thus, in the blocking position, the shaft 12 is also secured against a rotation about the axis of rotation of the shaft 14 relative to the housing 16.

In the release position, the blocking element 22 cannot engage any of the recesses 26. In other words, the blocking element 22 in the release position does not interact with the parking lock wheel 20 to the extent that the parking lock wheel 20 and thus the shaft 12 can rotate about the axis of rotation of the shaft 14 relative to the housing 16 in the release position. As previously described, because the respective wheel is connected to the shaft 12 in a torque-transferring manner, the respective wheel, in the blocking position, is secured against a rotation about the axis of rotation of the wheel relative to the structure and relative to the housing 16 by means of the blocking element 22. The motor vehicle is hereby secured against rolling away unintentionally, because the wheel cannot rotate relative to the structure. In the release position however, the respective wheel can rotate about the respective axis of rotation of the wheel relative to the structure to the extent that the motor vehicle, for example, can roll and/or be driven.

The parking lock 18 in this case comprises a preferably electrically drivable actuator 30, by means of which the blocking element 22 can be moved between the blocking position and the release position. In other words, the actuator 30 can move the blocking element 22 from the blocking position into the release position and from the release position into the blocking position. With the exemplary embodiment shown in FIG. 1, the blocking element 22 can be moved and thus displaced translationally, along a direction of movement indicated by a double arrow 32 in FIG. 1, between the release position and the blocking position, wherein the direction of movement, for example, extends diagonally, vertically, or skewed as relates to the axis of rotation of the shaft 14.

In order to then keep the installation space requirement, the weight, and the costs of the parking lock 18 and thus of the transmission 10 as a whole especially low, the parking lock 18 has a spring element 34, which is formed, for example, as a rotary spring in this case. The spring element 34 is to be tensioned by means of the actuator 30 during the moving of the blocking element 22 into the blocking position. In other words, if the blocking element 22 is moved from the release position into the blocking position by means of the actuator 30, the spring element 34 is tensioned by means of the actuator 30 during said movement. The spring element 34 is thereby tensioned, at least in the blocking position, to the extent that the spring element 34 provides a spring force at least in the blocking position. The actuator 30 is to be supported or is supported during the movement of the blocking element 22 from the blocking position into the release position by means of the spring force, which can be provided or is provided by the spring element 34 and, for example, is acting at least indirectly on the actuator 30 and/or the blocking element 22.

In order to prevent an undesired and automatic movement of the blocking element 22, which is initially in the blocking position, from the blocking position into the release position, it is preferably provided that the actuator 30 is formed as a self-locking actuator. The actuator 30 hereby has a self-locking function, by means of which the blocking element 22 is retained against the spring force provided by the spring element 34 in the blocking position. In other words, the self-locking function suppresses a movement of the actuator 30, wherein said movement is caused or can be caused by the spring force provided by the spring element 34, and said movement causes a movement of the blocking element 22 from the blocking position into the release position such that the blocking element 22 can be moved back and forth between the release position and the blocking position precisely and as needed by means of the actuator 30.

As previously indicated, the spring element 34 is formed as a rotary spring in the exemplary embodiment shown in FIG. 1, the spring force of which effects a torque, at least in the blocking position, by means of said torque the actuator 30 is supported during the movement of the blocking element 22 from the blocking position into the release position.

Furthermore, the parking lock 18 comprises a coupling element, which is formed as a coupling shaft 36, wherein the coupling shaft 36 is rotatable about an axis of rotation 38 relative to the housing 16. For example, the axis of rotation 38 extends perpendicular to a first plane, wherein the axis of rotation of the shaft 14, for example, extends perpendicular to a second plane. The first plane and the second plane extend, for example, perpendicular or diagonal to one another.

Via the coupling shaft 36, the blocking element 22 can be moved between the release position and the blocking position by means of the actuator 30 or by the actuator 30, to the extent that the actuator 30 is supported via the coupling shaft 36 during the movement of the blocking element 22 from the blocking position into the release position by means of the spring force. The previously mentioned torque in this case, which is indicated, for example, by an arrow 40 in FIG. 1, takes effect about the axis of rotation 38 of the coupling shaft 36, at least in the blocking position.

Furthermore, the actuator 30 is formed as an electric motor, which has a stator 42 and a rotor 44. The rotor 44 can be driven by the stator 42 and can thereby be rotated about an axis of rotation of the motor 46 relative to the stator 42 and relative to the housing 16. In this case, the coupling shaft 36 can be driven by the rotor 44. To this end, the coupling shaft 36, for example, is connected to the rotor 44 in a rotationally fixed manner, or the coupling shaft 36 is a component of the rotor 44 and, in doing so, is especially formed as a rotor shaft of the rotor 44. As shown in FIG. 1, the rotor 44 is arranged coaxially as relates to the coupling shaft 36 to the extent that the axis of rotation of the motor 46 coincides with the axis of rotation 38 of the coupling shaft 36.

A rotation of the coupling shaft 36 about the axis of rotation 38 and extending in a first direction of rotation is converted into a translational movement of the blocking element 22 extending in a first direction, for example, by means of a transmission device, particularly by means of worm gearing. The first direction is indicated by an arrow 48 in FIG. 1 and coincides with the direction of movement. For example, if the coupling shaft 36 is rotated about the axis of rotation 38 in a second direction of rotation opposite the first direction of rotation by means of the actuator 30, this rotation of the coupling shaft 36 is converted into a translational movement of the blocking element 22 extending in a second direction by means of the transmission device. In this case, the second direction is opposite the first direction and indicated by an arrow 50 in FIG. 1. In order to move, for example, the blocking element 22 from the release position into the blocking position, the blocking element 22 is moved into the first direction translationally. In order to move, for example, the blocking element 22 from the blocking position into the release position, the blocking element 22 is moved, for example, into the second direction translationally. As an alternative or in addition, the aforementioned transmission device, which is formed, for example, as worm gearing, has a self-locking function, by means of which the blocking element 22 is to be retained or is retained against the spring force provided by the spring element 34, at least in the blocking position. FIG. 1 further shows particularly well that the direction of movement extends diagonally, vertically, or skewed as relates to the axis of rotation 38. For example, the direction of movement (double arrow 32) extends perpendicular to a third plane, which extends, for example, perpendicular or preferably diagonal as relates to the first plane. The installation space requirement of the parking lock 18 and thus of the transmission 10 as a whole can hereby be kept especially low.

FIG. 2 shows two diagrams, 52 and 54, in order to further illustrate the parking lock 18, particularly the function thereof. A torque is applied to the respective y-axis 56, wherein said torque can be provided or is provided by the actuator 30, and particularly via the rotor 44.

FIG. 1 shows that the parking lock 18 has a locking linkage 58, by means of which the blocking element 22 can be moved by the actuator 30. In addition, a spring 60 is provided, which is also characterized as a locking linkage spring. If the actuator 30 is operated, for example, to move the blocking element 22 from the release position into the blocking position, while the blocking element 22, however, is not in alignment with one of the recesses 26, the aforementioned operation of the actuator 30 tensions the spring 60 by means of the actuator 30, particularly via the locking linkage 58, while a movement of the blocking element 22, for example, from the release position into the blocking position is suppressed. The spring 60 is thereby tensioned. If the shaft 12 and thus the parking lock wheel 20 are then rotated such that the blocking element 22 is in alignment or overlapping with one of the recesses 26, the spring 60 tension can be at least partially released, whereby the blocking element 22 is movable or is moved into the blocking position by means of the spring 60.

A nominal torque 62 of the actuator 30 is plotted in diagram 52, wherein the actuator 30 provides, for example, the nominal torque 62 in order to move the blocking element 22 from the release position into the blocking position. The torque caused by the spring force of the rotary spring in the blocking position is shown in FIG. 2 and designated as M_{F} therein. During moving of the blocking element 22 from the release position into the blocking position, the actuator 30 provides energy, which is stored in the spring element 34 and then effects the torque M_{F}. A torque, which is designated as M₂ in FIG. 2, is applied, for example, by the actuator 30 during moving of the blocking element 22 into the blocking position in order, for example, to tension or overpower the spring 60. In other words, the actuator 30 overpowers torque M_{F} and torque M₂ in order to move the blocking element 22 from the release position into the blocking position. This means that the actuator 30 overpowers the spring element 34, which is functioning as a pre-loaded spring, and the spring 60, which is formed as a locking linkage spring, in order to move the blocking element 22 from the release position into the blocking position. Torques M_{F} and M₂ result in a total torque, wherein a difference, designated as D in FIG. 2, between the total torque and the nominal torque 62 is provided as a safeguard in order to safely move the blocking element 22 from the release position into the blocking position by means of the actuator 30 and, in doing so, to overpower the pre-loaded spring and the locking linkage spring. As a whole, it can be discerned that the actuator 30 provides the nominal torque 62 in order to move the blocking element 22 from the release position into the blocking position, wherein torques M_{F} and M₂, for example, are parts of the nominal torque 62. Again, expressed in other words, the nominal torque 62 is used to overpower torques M_{F} and M₂, which oppose the movement of the blocking element 22 from the release position into the blocking position.

The blocking element 22 is tensioned very strongly with the parking lock wheel 20, particularly when the motor vehicle is parked on a slope or on an incline and the respective wheel is secured against a rotation exclusively by means of the parking lock 18. As a result, high gripping forces must be overcome by the actuator 30 in order to move the blocking element 22 from the blocking position into the release position, despite the strong tensioning.

Diagram 54 illustrates the movement of the blocking element 22 from the blocking position into the release position, wherein the movement is caused or can be caused by means of the actuator 30. In order to move the blocking element 22 from the blocking position into the release position, a release torque 64 must be applied, for example, to the coupling shaft 36. Because the spring element 34 supports the actuator 30 during moving of the blocking element 22 from the blocking position into the release position, the actuator 30 does not have to provide the release torque 64 alone; instead, the actuator 30 provides a first part T1 of the release torque 64 acting, for example, on the coupling shaft 36, which is less than the release torque 64. In this case, the spring element 34 provides a second part of the release torque 64, wherein the first part T1 and the second part as a whole result in at least the release torque 64. As shown in FIG. 2, the second part is torque M_{F} and is less than the release torque 64 in this case. The first part T1 and the second part are thus respective partial torques, which correspond to the release torque 64 in the cumulative or are greater than the release torque 64, but which are less than the release torque 64 when considered in isolation. In order to release the parking lock 18, the aforementioned parts or the partial torques are added together, whereby the actuator 30 and thus the parking lock 18 and thus the housing 10 as a whole can be designed especially beneficially with respect to weight, cost, and installation space. In other words, because the actuator 30 does not have to apply the release torque 64 alone, the actuator 30 can be dimensioned beneficially with respect to installation space and weight to the extent that the costs of the actuator 30 can be kept to an especially low scope. As a result, a structure of the parking lock 18 and of the transmission 10 as a whole can be ensured to be beneficial with respect to installation space, cost, and weight.

1-13. (canceled)

14. A parking lock for a motor vehicle, comprising:
a parking lock wheel which can be connected to a shaft of the motor vehicle in a rotationally fixed manner, at least one blocking element, and an actuator, by which the blocking element is moved between at least one blocking position securing the parking lock wheel against a rotation and at least one release position releasing the parking lock wheel for a rotation,
wherein at least one spring element which is to be tensioned by the actuator during the moving of the blocking element into the blocking position, and a spring force is thereby provided in the blocking position of the blocking element, by said force the actuator is to be supported during the movement of the blocking element into the release position.

15. The parking lock according to claim 14, wherein the actuator has a self-locking function, by which the blocking element is retained against the spring force provided by the spring element in the blocking position.

16. The parking lock according to claim 14, wherein the spring element is formed as a rotary spring, the spring force of which effects a torque, at least in the blocking position, by means of said torque the actuator is to be supported during the movement of the blocking element from the blocking position into the release position.

17. The parking lock according to claim 14, wherein at least one coupling element is provided, by means of which the blocking element can be moved by the actuator, wherein the spring force acts on the coupling element, at least in the blocking position, to the extent that the actuator is to be supported, via the coupling element, during the movement of the blocking element into the release position by means of the spring force.

18. The parking lock according to claim 14, wherein the coupling element is a coupling shaft which is rotatable about an axis of rotation.

19. The parking lock according to claim 18, wherein the torque takes effect about the axis of rotation of the coupling shaft, at least in the blocking position.

20. The parking lock according to claim 18, wherein the actuator is formed as an electric motor, which has a stator and a rotor, which can be driven by the stator and is thereby rotatable about an axis of rotation of the motor relative to the stator, wherein the coupling shaft can be driven by the rotor.

21. The parking lock according to claim 20, wherein the rotor is arranged coaxially as relates to the coupling shaft to the extent that the motor axis coincides with the axis of rotation.

22. The parking lock according to claim 14, wherein the blocking element can be moved along a direction of movement translationally between the release position and the blocking position.

23. The parking lock according to claim 22, wherein the direction of movement extends diagonally or skewed as relates to the axis of rotation.

24. A method for operating a parking lock for a motor vehicle, comprising:
a parking lock wheel which can be connected to a shaft of the motor vehicle in a rotationally fixed manner, at least one blocking element, and an actuator, by which the blocking element is moved between at least one blocking position securing the parking lock wheel against a rotation and at least one release position releasing the parking lock wheel for a rotation,
wherein at least one spring element which is tensioned by the actuator during the moving of the blocking element into the blocking position, and thereby provides a spring force in the blocking position of the blocking element, by said force the actuator is supported during the movement of the blocking element into the release position.

25. A transmission for a motor vehicle, comprising:
at least one parking lock with a parking lock wheel which can be connected to a shaft of the motor vehicle in a rotationally fixed manner, at least one blocking element, and an actuator, by which the blocking element is moved between at least one blocking position securing the parking lock wheel against a rotation and at least one release position releasing the parking lock wheel for a rotation,
wherein at least one spring element which is to be tensioned by the actuator during the moving of the blocking element into the blocking position, and a spring force is thereby provided in the blocking position of the blocking element, by said force the actuator is to be supported during the movement of the blocking element into the release position.

26. The parking lock according to claim 19, wherein the actuator is formed as an electric motor, which has a stator and a rotor, which can be driven by the stator and is thereby rotatable about an axis of rotation of the motor relative to the stator, wherein the coupling shaft can be driven by the rotor.

27. The parking lock according to claim 15, wherein the blocking element can be moved along a direction of movement translationally between the release position and the blocking position.

28. The parking lock according to claim 16, wherein the blocking element can be moved along a direction of movement translationally between the release position and the blocking position.

29. The parking lock according to claim 17, wherein the blocking element can be moved along a direction of movement translationally between the release position and the blocking position.

30. The parking lock according to claim 18, wherein the blocking element can be moved along a direction of movement translationally between the release position and the blocking position.

31. The parking lock according to claim 19, wherein the blocking element can be moved along a direction of movement translationally between the release position and the blocking position.

32. The parking lock according to claim 20, wherein the blocking element can be moved along a direction of movement translationally between the release position and the blocking position.

33. The parking lock according to claim 21, wherein the blocking element can be moved along a direction of movement translationally between the release position and the blocking position.
